(19) United States
(12) Patent Application Publication
(10) Pub. No.: US 2002/0147602 A1
(43) Pub. Date: Oct. 10, 2002

(54) Method and system for tracking units of an order

(76) Inventor: Gary Helms, Boise, ID (US)

Correspondence Address: PERKINS COIE LLP, PATENT-SEA, P.O. BOX 1247, SEATTLE, WA, 98111-1247, US

(21) Appl. No.: 09/833,026

(22) Filed: Apr. 10, 2001

(51) Int. Cl. G06F 17/60

(52) U.S. Cl. 705/1

(57) ABSTRACT

A method and system for interfacing with an existing order processing system to track orders to the unit level. The unit order system provides a unit order database that includes a record for each unit of each item of each order in the order database of the existing order processing system. The existing order processing system is used in its normal manner to update the order database. The unit order system periodically accesses the order database to identify new or changed orders. The unit order system then updates the unit order database to reflect the new, changed, or canceled orders. When a new order is identified, the unit order system adds a record to the unit order database for each unit of each item of each new order. The unit order system can track ship date, order date, cost information, and so on at the unit level.

### TECHNICAL FIELD

The described a technology relates generally to order management and particularly to a computer system for tracking of orders at the unit level.

### BACKGROUND

Current order processing systems, such as “ORACLE Order Entry” by Oracle Corp., provide for the tracking of orders at the item level. An item is a type of product that is being ordered. An item typically would have a stock keeping unit or some other product identifier associated with it. For example, a business may place an order from a PC manufacturer to purchase five identical desktop PCs with a product identifier of “PC101B” and four identical laptops with a product identifier of “LT098A.” The order would thus have two items: one item corresponding to the desktop PCs and the other item corresponding to the laptop. The desktop PC item would have a quantity of five units associated with it, and the laptop item would have a quantity of four units associated with it. The order processing systems would store the information describing each order in an order database. The order database would typically include an order table and an order item table. The order table would contain one record for each order that had been placed by a customer, and the order item table would contain one record for each item of each order that had been placed. Orders that are stored in the order database are said to be “booked” in the sense that the order is firm and financing has been approved.

Order processing systems typically allow orders to be modified after they have been booked. For example, a customer may decide to change the quantity of an item in an order, add a new item to the order, delete an item from an order, and so on. When the quantity of an item is changed, the order processing systems simply update a quantity field in the corresponding record of the order item table. When a new item is ordered, then a new record is added to the order item table. When an item is deleted from the order, then the corresponding record of the order item table is deleted. Thus, the order database provides the current state of an order but does not provide historical information on the various changes that have been made to the order. For example, no information is stored in the order database to indicate changes made to an order. In addition, order processing systems typically track ship date and order date at the order level and not at the item level or individual unit level. Thus, all items within an order appear to have been ordered and shipped on the same days. When order processing systems support costing of product, they typically only support costing at the item level and not at the individual unit level. The order processing system may store a single cost in a record of the order item table that applies to each unit of that item, rather than having a separate cost for each unit.

These order processing systems have several disadvantages. First, because historical information is not stored, various reports may seem inconsistent. For example, the total quantity of a certain product that was ordered during the previous quarter may vary depending on when the total quantity is calculated. Because the order date is at the order level and historical information is not tracked, a change this quarter in the quantity for the certain product on an order placed last quarter will result in a change in the total quantity ordered for the last quarter. Thus, reports for last quarter that are generated before and after the change will have different total quantities. Second, because ship date is only stored at the order level, orders that have units shipped on the different dates cannot be properly accounted. For example, an order for 10 PCs may have one of the PCs shipped on the last day of quarter and the remaining nine PCs shipped on the first day of the following quarter. Since the ship date is typically the date the first item of an order is shipped, it would appear that all 10 of the PCs were shipped in the previous quarter. Thus, a calculation of revenue for the previous quarter may incorrectly factor in the nine PCs that were really shipped in the current quarter.

It would be desirable to have a technique for using existing order processing systems that would allow for tracking of historical information relating to an order and for tracking orders at the unit level so that accounting systems can more accurately project revenue, profits, cost, and so on.

### BRIEF DESCRIPTION OF THE DRAWINGS

FIG. 1 is a block diagram illustrating components of an order processing system and the unit order system in one embodiment.

FIG. 2 is a block diagram illustrating tables of the various databases of the order processing system and unit order system in one embodiment.

FIG. 3 is a flow diagram illustrating the processing of the update unit order component in one embodiment.

FIG. 4 is a flow diagram illustrating the processing of the processed changed orders component in one embodiment.

FIG. 5 is a flow diagram illustrating the processing of the process new order component in one embodiment.

FIG. 6 is a flow diagram illustrating the processing of the add item to booked history component in one embodiment.

FIG. 7 is a flow diagram illustrating the processing of the processed new items component in one embodiment.

FIG. 8 is a flow diagram illustrating the processing of the process updated items component in one embodiment.

FIG. 9 is a flow diagram illustrating the processing of the process uncanceled items component in one embodiment.

FIG. 10 is a flow diagram illustrating the processing of the processed deleted items component in one embodiment.

FIG. 11 is a flow diagram illustrating the processing of the processed backlogged orders component in one embodiment.

FIG. 12 is a flow diagram illustrating the processing of the update ship date component in one embodiment.

FIG. 13 is a flow diagram illustrating the processing of the update date confirmed component in one embodiment.

FIG. 14 is a flow diagram illustrating the processing of the close records component in one embodiment.

### DETAILED DESCRIPTION

A method and system for interfacing with an existing order processing system to track orders to the unit level is provided. In one embodiment, the unit order system provides a unit order database that includes a record for each unit of each item of each order in the order database of the existing order processing system. The existing order processing system is used in its normal manner to update the order database. The unit order system periodically accesses the order database to identify new or changed orders. The unit order system then updates the unit order database to reflect the new, changed, or canceled orders. When a new order is identified, the unit order system adds a record to the unit order database for each unit of each item of each new order. For example, if a new order is placed for five desktop PCs and four laptops, then the unit order system adds nine records to the unit order database. In this way, the unit order system can track ship date, order date, cost information, and so on at the unit level. When a change in the quantity of an item of order is identified, the unit order system adds records to the unit order database corresponding to any increased quantity of units and marks as canceled existing records in the unit order database corresponding to any decreased quantity of units. Thus, the unit order database maintains historical information on changes to the orders at the unit level. The unit order system periodically identifies the backlogged units (booked units that have not yet had all their ordered units shipped or canceled) and determines whether the status of each unit of backlogged unit has recently changed. For example, the unit order system may access a shipping system to determine whether any units for an order have shipped within the last day. If so, then the unit order system may update the corresponding records in the unit order database to indicate that the unit has been shipped. In this way, the unit order database allows shipments to be track at the unit level, rather than the order level. The unit order system may retrieve cost information for each unit of each item and store the cost information in the unit order database so that the cost of each unit can also be individually track.

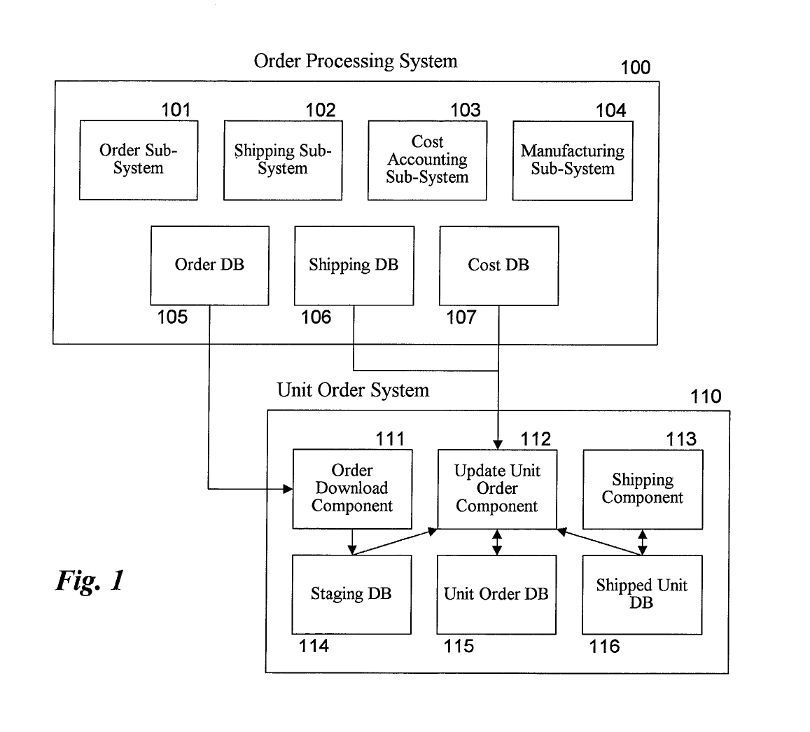

FIG. 1 is a block diagram illustrating components of an order processing system and the unit order system in one embodiment. The conventional order processing system 100 includes an order subsystem 101, a shipping subsystem 102, a cost accounting subsystem 103, a manufacturing subsystem 104, an order database 105, a shipping database 106, and a cost database 107. The order subsystem controls the adding and changing of the orders that are stored in the order database. The shipping subsystem records shipping-related information in a shipping database, such as serial numbers of units shipped for an order. The manufacturing subsystem uses the information from the order database to control the manufacturing process. The cost accounting subsystem tracks cost-related information for each unit that is manufactured. The unit order system 110 includes an order download component 111, an update unit order component 112, a shipping component 113, a staging database 114, a unit order database 115, and a shipped unit database 116. The order download component periodically accesses the order database and updates the staging database so that the staging database is synchronized with the order database. The staging database contains all the information of the order database that is needed by the unit order system. In one embodiment, the staging database may be omitted, and the unit order system can retrieve the information of the staging database from the order database as needed. The update unit order component is responsible for updating the unit order database on a periodic basis to ensure that it reflects changes that have been made to the order database. The update unit order component also updates status in the records of the unit order database for backlogged orders to reflect the current status of their units. The shipping component allows information to be collected as to when each individual unit has been shipped and to be stored in the shipped unit database.

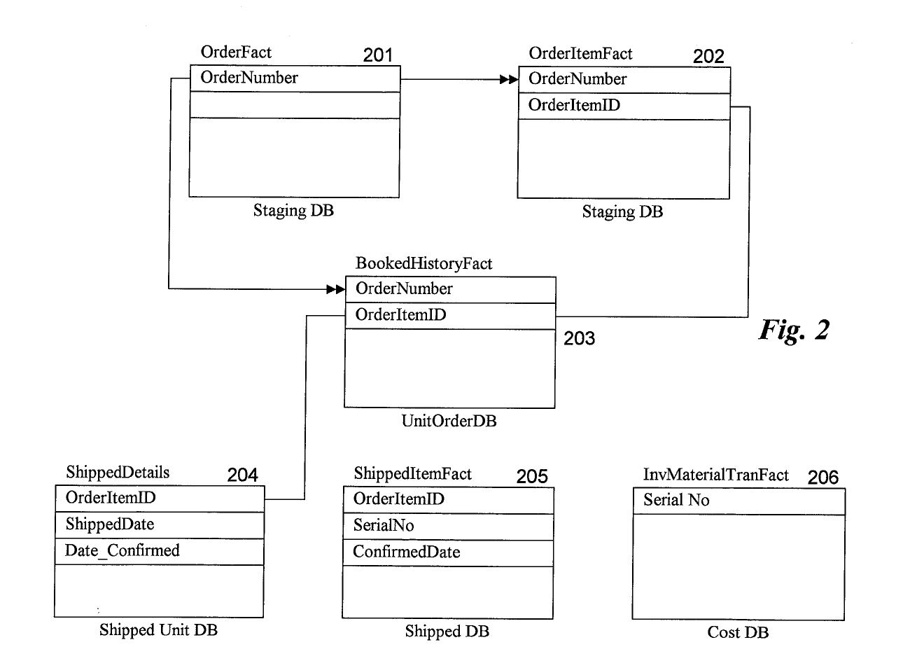

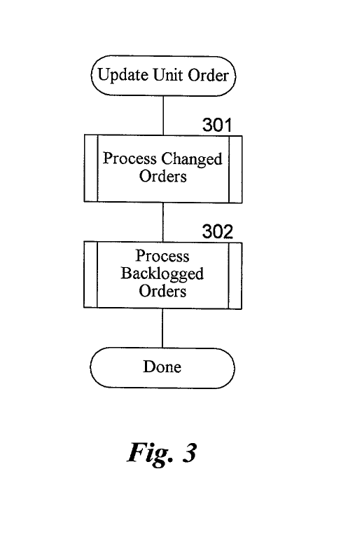

FIG. 2 is a block diagram illustrating tables of the various databases of the order processing system and unit order system in one embodiment. The order fact table 201 and the order item fact table 202 are tables of the staging database. The order fact table contains a record for each order of the order database, and the order item fact table contains a record for each item of each order that is in the order database. Each record of the order fact table includes a unique order number, and each record of the order item fact table includes the corresponding order number and a unique order item identifier. The booked history fact table 203 is the primary table of the unit order database and contains a record for each unit of each item that has been ordered, even if in the unit has been canceled. Each record of the book history fact table identifies the corresponding order number and the corresponding order item identifier. The shipped details table 204 is a table of the shipped unit database and contains a record for each unit that has been shipped and identifies the order item identifier of the corresponding item, the ship date of the unit, and the date that the shipment was confirmed. The shipped item fact table 205 is a table of the shipping database of the order processing system and contains a record for each item that has had a unit shipped. Each record includes the order item identifier, serial number of the shipped unit and confirmed date of the shipment. The inventory material transaction fact table 206 is a table of the cost database of the order processing system and contains a record for each unit that has been manufactured. The records contain the serial number of the unit, the order item identifier, and the cost. FIGS. 3-14 are flow diagrams illustrating processing of the unit order processing system in one embodiment.

FIG. 3 is a flow diagram illustrating the processing of the update unit order component in one embodiment. The update unit order component runs periodically, such as daily, and is responsible for updating the unit order database to reflect any changes that have been made to the orders of the order database by the order processing system. In block 301, the component processes any new or changed orders of the order database to ensure that records of the unit order database have been updated to reflect those changes. The component invokes the process changed order component that is described below. In block 302, the component processes backlogged orders to update the status of their units in the unit order database. A backlogged order is any order booked order that has not yet had all its units shipped. The component invokes the process backlogged orders component that is described below. The component then completes.

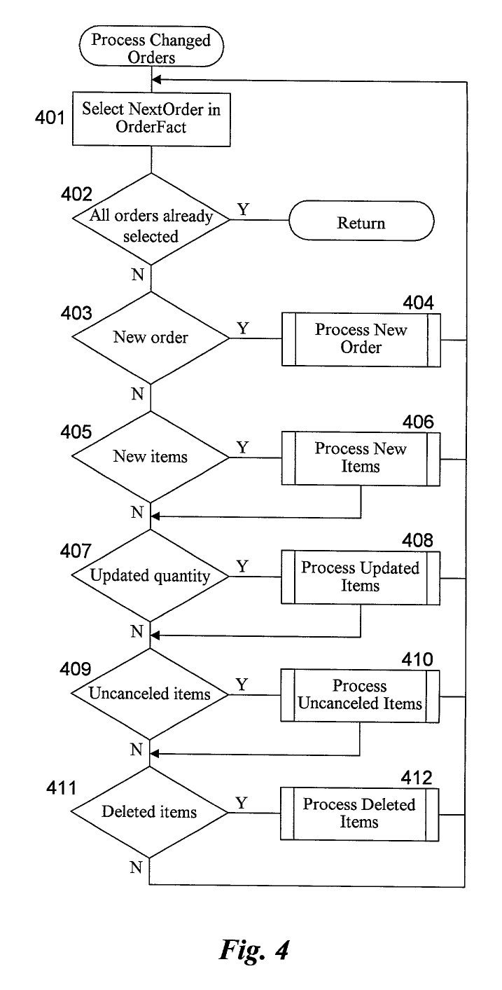

FIG. 4 is a flow diagram illustrating the processing of the processed changed orders component in one embodiment. The component loops processing each order in the order fact table of the staging database. The component determines whether each order is a new order, has new items, has updated quantities, has uncanceled items, or has deleted items and then updates the booked history fact table of the unit order database accordingly. In block 401, the component selects the next order from the order fact table starting with the first order. In decision block 402, if all orders in the order fact table have already been selected, then the component returns, else the component continues at block 403. In decision block 403, if the selected order is a new order, then the component continues at block 404, else the component continues at block 405. The component identifies an order as new when the booked history fact table has no records corresponding to that order. In block 404, the component invokes the processed new order component passing an indication of the selected order and then loops to block 401 to select the next order. In decision block 405, if the selected order has new items, then the component continues at block 406, else the component continues at block 407. The component determines whether an order has new items when there are no corresponding records in the booked history fact table for an item of the order. In block 405, the component invokes the processed new items component passing an indication of the selected order and then continues at block 407. In decision block 407, if the quantity of an item of the selected order has changed, then the component continues at block 408, else the component continues at block 409. The component determines whether an item has had its quantity updated by counting the corresponding records of the booked history fact table. In block 408, the component invokes the process updated item component passing an indication of the selected order and then continues at block 409. In decision block 409, if the selected order as an item that is uncanceled, then the component continues at block 410, else the component continues at block 411. The component determines whether an order has an item that has been uncanceled when the corresponding records in the booked history fact table indicates that the item had been canceled. In block 410, the component invokes the process uncanceled items component passing an indication of the selected order and then continues at block 411. In decision block 411, if an item of the selected order has been deleted, then the component continues at block 412, else the component loops to block 401 to select the next order. The component determines whether an item of an order has been deleted by detecting a record of the booked history fact table for that order that has no corresponding item in the order item fact table. In block 412, the component invokes the process deleted items component passing an indication of the selected order and then loops to block 401 to select the next order.

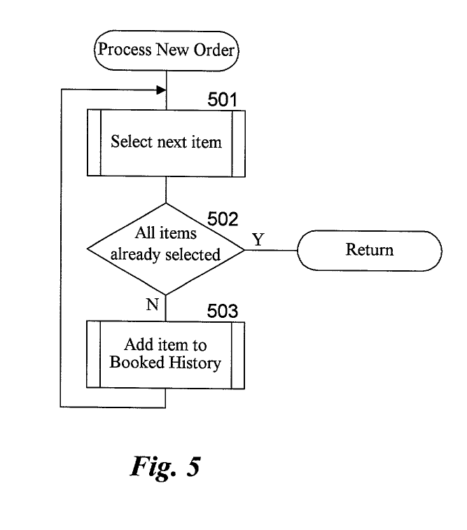

FIG. 5 is a flow diagram illustrating the processing of the process new order component in one embodiment. This component selects each item of the passed order and adds corresponding records to the booked history fact table for each unit of each item. In block 501, the component selects the next item of the passed order. In decision block 502, if all the items of the passed order have already been selected, then the component returns, else the component continues at block 503. In block 503, the component invokes the add item to booked history component passing an indication of the selected item to add records for the selected item to the booked history fact table. The component then loops to block 501 to select the next item.

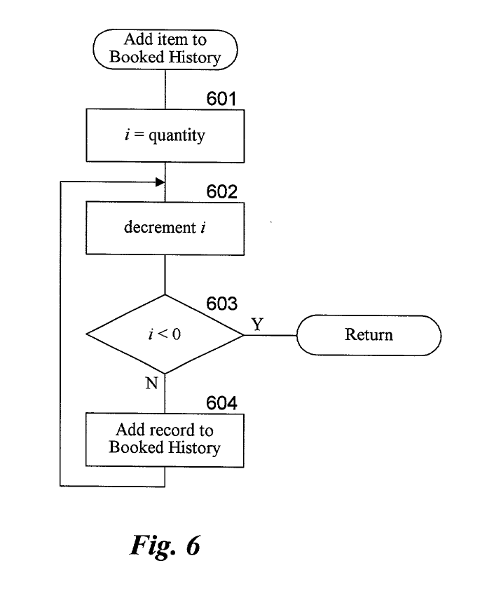

FIG. 6 is a flow diagram illustrating the processing of the add item to booked history component in one embodiment. The component is passed an item and adds a record to the booked history fact table for each unit of the item. In block 601, the component sets a counter equal to the quantity of the units in the passed item. In block 602, the component decrements the counter. In decision block 603, if the counter is less than zero, then a record for each unit of the passed item has been added to the booked history fact table and the component returns, else the component continues at block 604. In block 604, the component adds a record to the booked history fact table and then loops to block 602.

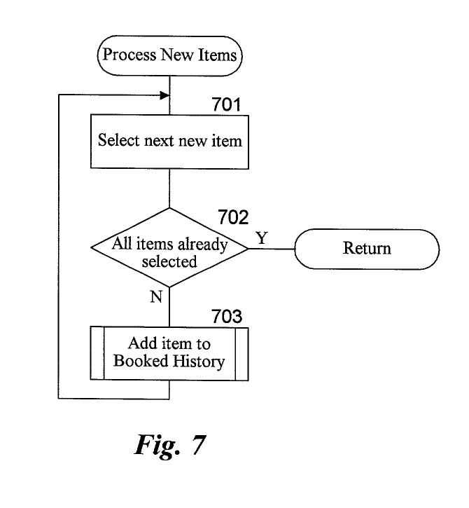

FIG. 7 is a flow diagram illustrating the processing of the process new items component in one embodiment. The component adds records to the booked history fact table corresponding to the units of a new item that has been added to the passed order. In block 701, the component selects the next new item of the passed order. In decision block 702, if all the new items of the passed order have already been selected, then the component returns, else the component continues at block 703. In block 703, the component invokes the add item to booked history component passing an indication of the selected item to add records for the selected item to the booked history fact table. The component then loops to block 701 to select the next new item.

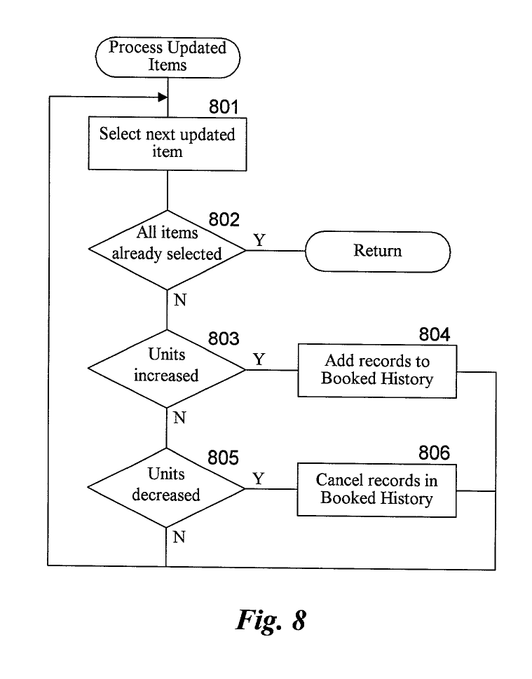

FIG. 8 is a flow diagram illustrating the processing of the process updated items component in one embodiment. The component updates the records of the booked history fact table to reflect changes in the quantity of an item of the passed order. In block 801, the component selects the next updated item of the passed order. In decision block 802, if all the updated items of the passed order have already been selected, then the component returns, else the component continues at block 803. In decision block 803, if the quantity of units for the selected item has increased, then the component continues at block 804, else the component continues at block 805. The component determines that the quantity of units has increased by comparing the quantity of the item with the quantify reflected in the corresponding records for that item in the booked history fact table. In block 804, the component add records to the booked history fact table corresponding to the increased quantity of units and then loops to block 801 to select the next updated item. In decision block 805, if the quantity of units for the selected item has decreased, then the component continues at block 806, else the component loops to block 801 to select the next updated item. The component determines whether the quantity of units has decreased by comparing the quantity in the item with the quantity reflected in the corresponding records for that item in the booked history fact table. In block 806, the component marks as canceled the records corresponding to the decreased quantity in the booked history fact table and then loops to block 801 to select the next updated item.

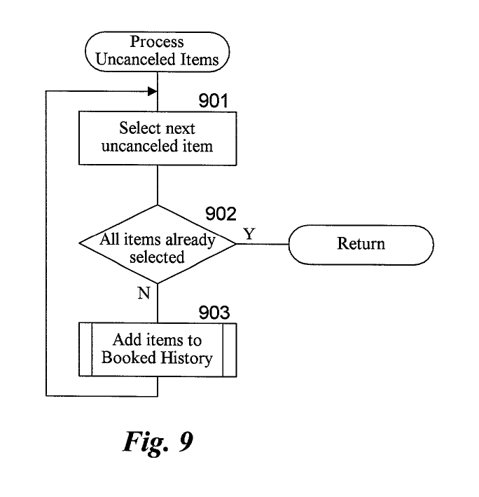

FIG. 9 is a flow diagram illustrating the processing of the process uncanceled items component in one embodiment. The component is passed an order with an uncanceled item and updates the booked history fact table accordingly. In block 901, the component selects the next uncanceled item of the passed order. In decision block 902, if all the uncanceled items of the passed order have already been selected, then the component returns, else the component continues at block 903. In block 903, the component invokes the add item to booked history component passing an indication of the selected item to add records for the selected item to the booked history fact table. The component then loops to block 901 to select the next uncanceled item.

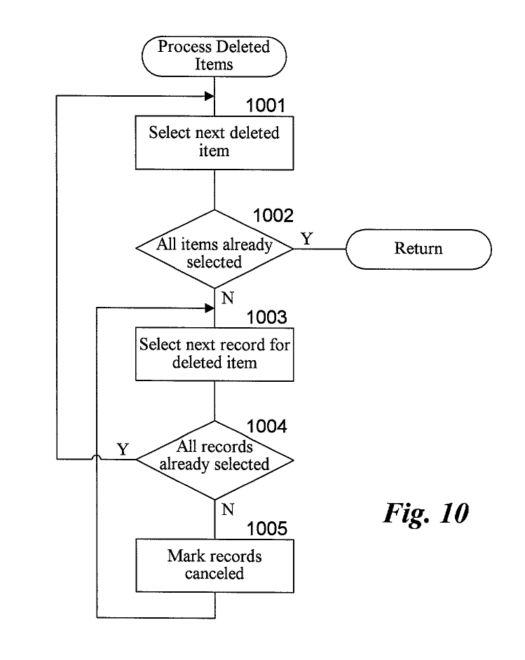

FIG. 10 is a flow diagram illustrating the processing of the processed deleted items component in one embodiment. The component marks as canceled records of the booked history fact table corresponding to the deleted items of the passed order. In block 1001, the component selects the next record for the canceled item of the passed order. In decision block 1002, if all the deleted items of the passed order have already been selected, then the component returns, else the component continues at block 1003. In block 1003, the component selects the next record for the deleted item from the booked history fact table. In decision block 1004, if all the records for the selected item have already been selected, then the component loops to block 1001 to select the next deleted item, else the component continues at block 1005. In block 1005, the component marks as canceled the selected record and then loops to block 1003 to select the next record for the selected item.

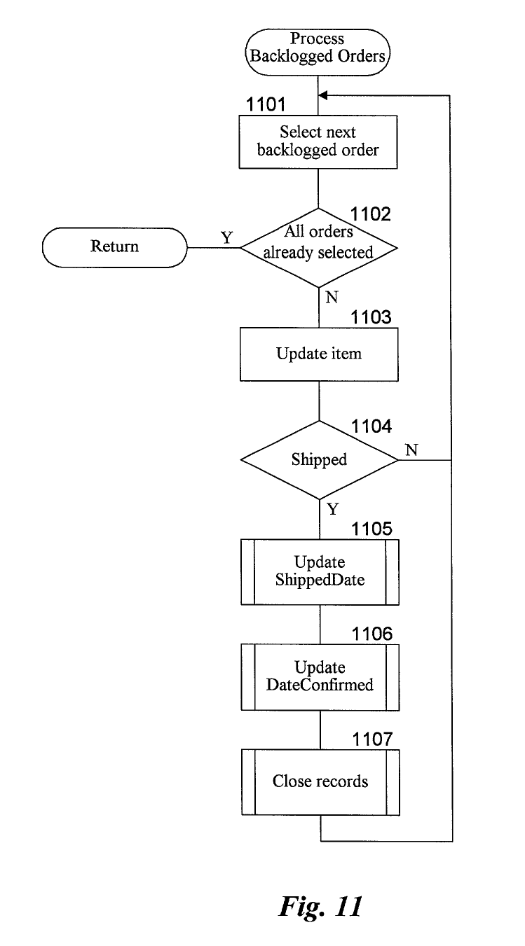

FIG. 11 is a flow diagram illustrating the processing of the process backlogged orders component in one embodiment. The component loops selecting each backlogged order in the unit order database, updating the corresponding records of the booked history fact table with information from the order fact table and the order item fact table, and updating the status of each record. In block 1101, the component selects the next backlogged order of the unit order database. In decision block 1102, if all the backlogged orders from the unit order database have already been selected, then the component returns, else the component continues at block 1103. In block 1103, the component updates the status and business metrics for the respective order records in the booked history fact table. In decision block 1104, if the selected order has been shipped as indicated by the ship date in the order fact table, then the component continues at block 1105, else the component loops to block 1101 to select the next backlogged order. In block 1105, the component invokes the update ship date component passing an indication of the selected order to update ship dates as appropriate for the records in the unit order database. In block 1106, the component invokes the update date confirmed component passing an indication of the selected order to update the date confirmed as indicated by the shipped database. In block 1107, the component invokes a close records component passing an indication of the selected order to determine whether any of the records should have their status set to closed. The component then loops to block 1101 to select the next backlogged order.

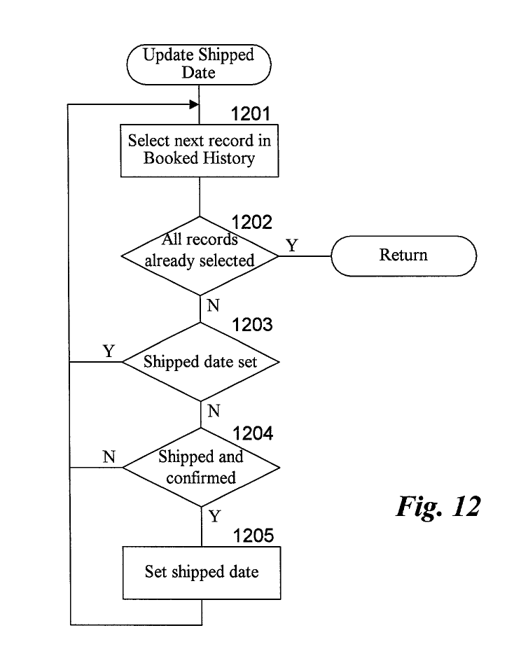

FIG. 12 is a flow diagram illustrating the processing of the update ship date component in one embodiment. The component determines whether the ship date in the records of the booked history fact table for the passed backlogged order should be updated. In block 1201, the component selects the next record in the booked history fact table for the passed order. In decision block 1202, if all the records for the passed order have already been selected, then the component returns, else the component continues at block 1203. In decision block 1203, if the ship date has been set in the selected record, then the component loops to block 1201 to select the next record, else the component continues at block 1204. In decision block 1204, if a unit corresponding to the selected record has been shipped and confirmed as indicated by the shipped header table of the shipped unit database, then the component continues at block 1205, else the component loops to block 1201 to select the next record. In block 1205, the component sets the ship date in the selected record to the ship date of the shipped header table and then loops to block 1201 to select the next record.

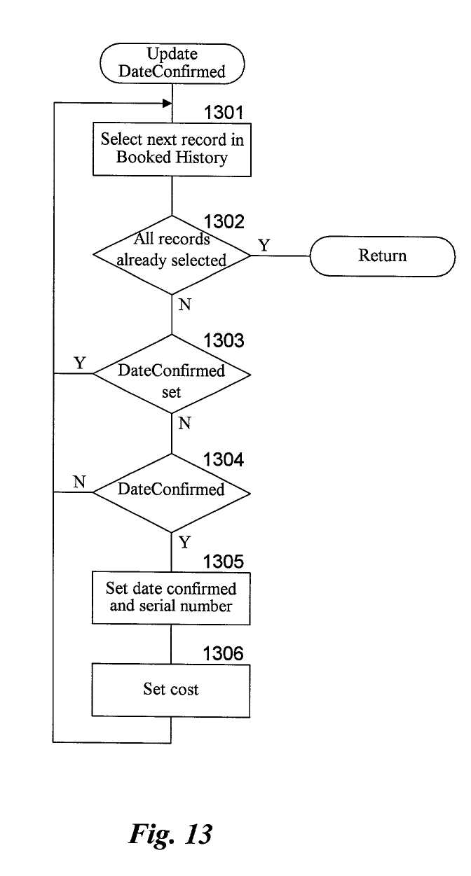

FIG. 13 is a flow diagram illustrating the processing of the update date confirmed component in one embodiment. The component processes each record in the booked history fact table for the passed order to determine whether the order processing system has indicated that the ship date has been confirmed. In block 1301, the component selects the next record in the booked history fact table for the passed order. In decision block 1302, if all the records for the passed order have already been selected, then the component returns, else the component continues at block 1303. In decision block 1303, if the date confirmed has been set in the selected record, then the component loops to block 1301 to select the next record, else the component continues at block 1304. In decision block 1304, if the date is confirmed as indicated by the shipped item fact table of the shipped database, then the component continues at block 1305, else the component loops to block 1301 to select the next record. In block 1305, the component sets the date confirmed and serial number in the selected record based on the shipped item fact table. In block 1306, the component sets cost information in the selected record and then loops to block 1301 to select the next record.

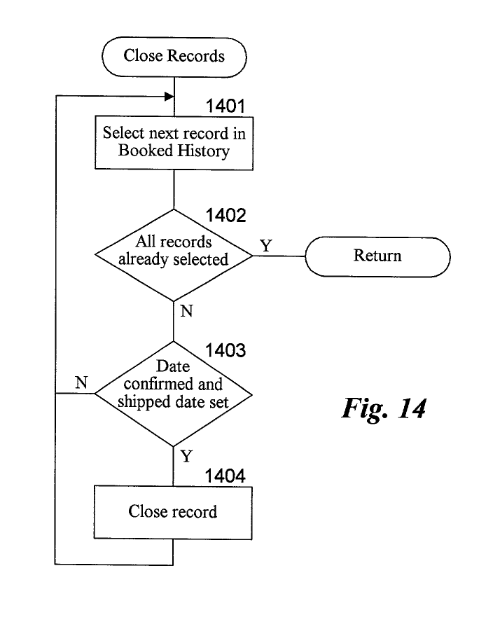

FIG. 14 is a flow diagram illustrating the processing of the close records component in one embodiment. The component determines whether the records of the passed order should be closed. A record should be closed when both its date confirmed and ship dates have been set. In block 1401, the component selects the next record in the booked history fact table for the passed order. In decision block 1402, if all the records in the booked history fact table for the passed order have already been selected, then the component returns, else the component continues at block 1403. In decision block 1403, if the date confirmed and ship date are both set in the selected record, then the component continues at block 1404, else the component loops to block 1401 to select the next record. In block 1404, the component marks as closed the selected record and loops to block 1401 to select the next record.

Although the technology has been described in terms of a preferred embodiment, the invention is not limited to these embodiments. Modifications within the scope of the invention will be apparent to those skilled in the art. The scope of the invention is defined by the claims that follow.

1. A method in a computer system for tracking orders for multiple units of items, each order having one or more items, each item having an associated quantity of units of that item, the method comprising:
providing an order database with a plurality of orders that have been booked, the order database being updated to reflect current orders;
updating a unit order database to include a record for each unit of each item of each order of the order database; and
when status of a unit of an item of an order changes, setting a status in a record of the unit order database for a unit of the item of the order to reflect the changed status
so that the status of each unit of each item of an order can be tracked separately.

2. The method of claim 1 wherein the updating of the unit order database includes adding a record for each unit of each item for each new order of the order database.

3. The method of claim 2 including identifying that an order in the order database is new when the unit order database contains no records corresponding to that order.

4. The method of claim 1 wherein the updating of the unit order database includes when the quantity of units of an item of an existing order has changed,
adding a record for increased unit of the item; and
setting a record to canceled for each decreased unit of the item.

5. The method of claim 4 including identifying that the quantity of units of an item of an existing order has changed by comparing the quantity of units of the item indicated in the order database to a quantity of units of the item indicated by the records of that order in the unit order database.

6. The method of claim 1 wherein the updating of the unit order database includes adding a record for each unit of each item of each uncanceled order of the order database.

7. The method of claim 1 wherein the updating of the unit order database occurs on a periodic basis.

8. The method of claim 7 wherein the period is daily.

9. The method of claim 1 wherein the status is shipping status and the set status is ship date of the unit.

10. The method of claim 1 wherein the status is open or closed and the set status indicates closed when the unit of the item has been shipped and cost information has been provided.

11. A computer system for tracking orders for multiple units of items, each order having one or more items, each item having an associated quantity of units of that item, comprising:
means for updating a unit order database to include a record for each unit of each item of each order of an order database, the order database having orders that have been booked, the order database being updated to reflect current orders; and
means for setting a status in a record of the unit order database for a unit of the item of the order to reflect a changed status when the status of a unit of an item of an order changes
so that the status of each unit of each item of an order can be tracked separately.

12. The computer system of claim 11 wherein the means for updating of the unit order database includes means for adding a record for each unit of each item for each new order of the order database.

13. The computer system of claim 12 including means for identifying that an order in the order database is new when the unit order database contains no records corresponding to that order.

14. The computer system of claim 11 wherein the means for updating of the unit order database includes when the quantity of units of an item of an existing order has changed, adding a record for increased unit of the item and setting a record to canceled for each decreased unit of the item.

15. The computer system of claim 14 including identifying that the quantity of units of an item of an existing order has changed by comparing the quantity of units of the item indicated in the order database to a quantity of units of the item indicated by the records of that order in the unit order database.

16. The computer system of claim 11 wherein the means for updating of the unit order database includes adding a record for each unit of each item of each uncanceled order of the order database.

17. The computer system of claim 11 wherein the updating of the unit order database occurs on a periodic basis.

18. The computer system of claim 17 wherein the period is daily.

19. The computer system of claim 11 wherein the status is shipping status and the set status is ship date of the unit.

20. The computer system of claim 11 wherein the order database is a database of the ORACLE Order Entry system.

21. The computer system of claim 11 wherein the status is open or closed and the set status indicates closed when the unit of the item has been shipped and cost information has been provided.

22. A computer-readable medium containing instructions for controlling a computer system to track orders for multiple units of items, each order having one or more items, each item having an associated quantity of units of that item, the orders being stored in an order database that is updated to reflect current orders, by a method comprising:
updating a unit order database to include a record for each unit of each item of each order of the order database; and
when status of a unit of an item of an order changes, setting a status in a record of the unit order database for a unit of the item of the order to reflect the changed status
so that the status of each unit of each item of an order can be tracked separately.

23. The computer-readable medium of claim 22 wherein the updating of the unit order database includes adding a record for each unit of each item for each new order of the order database.

24. The computer-readable medium of claim 23 including identifying that an order in the order database is new when the unit order database contains no records corresponding to that order.

25. The computer-readable medium of claim 22 wherein the updating of the unit order database includes when the quantity of units of an item of an existing order has changed, adding a record for increased unit of the item and setting a record to canceled for each decreased unit of the item.

26. The computer-readable medium of claim 25 including identifying that the quantity of units of an item of an existing order has changed by comparing the quantity of units of the item indicated in the order database to a quantity of units of the item indicated by the records of that order in the unit order database.

27. The computer-readable medium of claim 22 wherein the updating of the unit order database includes adding a record for each unit of each item of each uncanceled order of the order database.

28. The computer-readable medium of claim 22 wherein the updating of the unit order database occurs on a periodic basis.

29. The computer-readable medium of claim 28 wherein the period is daily.

30. The computer-readable medium of claim 22 wherein the status is shipping status and the set status is ship date of the unit.

31. The computer-readable medium of claim 22 wherein the status is open or closed and the set status indicates closed when the unit of the item has been shipped and cost information has been provided.

32. A method in a computer system for tracking orders for multiple units of items at an individual unit level when an order entry system supports tracking only at the order or item level, the method comprising:
periodically identifying changes to orders of an order database of the order entry system; and
updating a unit order database to reflect the identified changes to the orders of the order database, the unit order database having a record for each unit of each item of each unit so that the status of each unit of each item of an order can be tracked separately.

33. The method of claim 32 wherein the updating of the unit order database includes adding a record for each unit of each item for each new order of the order database.

34. The method of claim 33 including identifying that an order in the order database is new when the unit order database contains no records corresponding to that order.

35. The method of claim 32 wherein the updating of the unit order database includes when the quantity of units of an item of an existing order has changed, adding a record for increased unit of the item and setting a record to canceled for each decreased unit of the item.
